(19) United States
(12) Patent Application Publication
(10) Pub. No.: US 2017/0193087 A1
(43) Pub. Date: Jul. 6, 2017

(54) Real-Time Markup of User Text with Deep Links

(71) Applicant: Quixey, Inc., Mountain View, CA (US)

(72) Inventors: Taher SAVLIWALA, Mountain View, CA (US); Jonathan BEN-TZUR, Sunnyvale, CA (US)

(21) Appl. No.: 14/986,564

(22) Filed: Dec. 31, 2015

(51) Int. Cl. G06F 17/30; G06F 17/24; G06F 17/22; H04M 3/42; H04L 12/58

(52) U.S. Cl. CPC G06F 17/30684; G06F 17/30696; G06F 17/30699; H04M 3/42382; H04L 51/04; H04L 51/08; G06F 17/2235; G06F 17/24

(57) ABSTRACT

A messaging system receives text typed by a user into a user device. An entity identification engine selectively identifies an entity within the received text based on a set of entities stored in an entity data store. A natural language action recognition engine selectively identifies a phrase corresponding to an action within the received text. A deep link identification module, in response to identifying the entity and the action, modifies a display on the user device to visually emphasize the text corresponding to the identified entity and/or action. A search system interface, in response to the user selecting the portion of the text, transmits a query to a search system, including the identified entity and action. In response, each of a set of application state results includes an identification of an application within which the application state is present and an access mechanism that navigates to the application state.

### FIELD

The present disclosure relates to messaging applications and more particularly to rich text features of messaging applications for mobile devices.

### BACKGROUND

With the proliferation of mobile devices and mobile applications (equivalently, apps), finding and sharing relevant content can no longer be done just with web URLs (Uniform Resource Locators). Unlike the web, there is no single URL format to describe a specific state of a specific app. However, a varied set of technologies called deep linking allows a URI (Uniform Resource Identifier) to specify a particular state and, in some operating systems and for some apps, transition a user device to that particular state on behalf of the user.

Deep linking technology is seeing increasing use on mobile platforms. When a user searches for a particular restaurant, instead of simply seeing the web page of the restaurant or a link to a restaurant application such as the YELP restaurant review application, the user may be presented with a deep link that will take the user directly to the state of the YELP restaurant review application where that restaurant is reviewed. However, sharing deep links with contacts is often not seamless or even possible.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A messaging system includes an input buffer configured to receive text typed by a first user into a first user device. An entity identification engine is configured to selectively identify an entity within the received text based on a set of entities stored in an entity data store. A natural language action recognition engine is configured to selectively identify a phrase corresponding to an action within the received text. A deep link identification module is configured to, in response to (i) the entity identification engine identifying the entity in the received text and (ii) the natural language action recognition engine identifying the action in the received text, modify a display on the first user device to visually emphasize a portion of the text typed by the first user. The portion of the text corresponds to at least one of the identified entity and the identified action. A search system interface is configured to, in response to the first user expressing interest in the portion of the text, transmit a query to a search system. The query includes the identified entity and the identified action. The search system interface is configured to receive a set of application state results. Each application state result includes (i) an identification of an application within which the application state is present, (ii) an identification of the application state, and (iii) an access mechanism that navigates to the application state within the first user device. The search system interface is configured to cause the set of application state results to be presented to the first user.

In other features, the visually emphasizing the portion of the text includes at least one of adding a hyperlink to the portion of the text and replacing the portion of the text with a button containing the portion of the text. In other features, the entity identification engine is configured to selectively identify one or more entities within the received text. The search system interface is configured to include all of the one or more entities in the query sent to the search system. In other features, the input buffer, the entity identification engine, the natural language action recognition engine, the deep link identification module, and the search system interface are included in a library. The library is integrated into a messaging application. The messaging application is installed on the first user device. The messaging application receives the text typed by the first user. The messaging application displays, on the first user device, the text typed by the first user.

In other features, the entity identification engine, the natural language action recognition engine, the deep link identification module, and the search system interface are implemented in a messaging server remote from the first user device. A messaging application installed on the first user device receives the text typed by the first user and displays, on the first user device, the text typed by the first user. In other features, the entity identification engine is configured to selectively identify an entity within a message from a second user. The natural language action recognition engine is configured to selectively identify a phrase corresponding to an action within the message from the second user. The deep link identification module is configured to, in response to (i) the entity identification engine the identifying the entity in the message and (ii) the natural language action recognition engine identifying the action in the message, modify the display on the first user device to visually emphasize a portion of the message.

In other features, the deep link identification module is configured to, in response to (i) the natural language action recognition engine identifying the action in the received text and (ii) the entity identification engine having previously identified an entity in the received text, modify the display on the first user device to visually emphasize a second portion of the text typed by the first user. The second portion of the text corresponds to the identified action. In other features, the entity identification engine is configured to identify the entity within the received text based on (i) a set of entities stored in an entity data store and (ii) a set of pattern matching rules.

A system includes the messaging system of claim 1 and the search system. The search system includes a search function data store configured to store a plurality of records. Each record (i) identifies search functionality of a respective application, (ii) includes a path to reach a search input state corresponding to the identified search functionality within the respective application, and (iii) includes an indication of required input parameters to be supplied in the search input state to access the identified search functionality. The search system includes a search function matcher configured to, in response to the query, select a set of records from the search function data store. Each record of the selected set of records (i) has required input parameters that match the identified entity of the query and (ii) has search functionality corresponding to the identified action of the query.

In other features, the search system includes a native search system configured to, for each record of the set of records, control an emulator to navigate the application specified by the record to the search input state specified by the record, supply the required input parameters to the search input state specified by the record, perform a search, and scrape content from a resulting state to produce a content object. The content object includes a path to a first result specified by the resulting state. The search system transmits the content objects to the messaging system. In other features, the search system transmits an order with the content objects. The order is determined based on sponsorship of respective applications from which the content objects were obtained.

A method of operating a messaging system includes receiving text typed by a first user into a first user device. The method includes selectively identifying an entity within the received text based on a set of entities stored in an entity data store. The method includes selectively identifying a phrase within the received text corresponding to an action. The method includes, in response to the entity and the action being identified in the received text, modifying a display on the first user device to visually emphasize a portion of the text typed by the first user. The portion of the text corresponds to at least one of the identified entity and the identified action. The method includes, in response to the first user expressing interest in the portion of the text, transmitting a query to a search system. The query includes the identified entity and the identified action. The method includes receiving a set of application state results. Each application state result includes (i) an identification of an application within which the application state is present, (ii) an identification of the application state, and (iii) an access mechanism that navigates to the application state within the first user device. The method includes causing the set of application state results to be presented to the first user.

In other features, the visually emphasizing the portion of the text includes at least one of adding a hyperlink to the portion of the text and replacing the portion of the text with a button containing the portion of the text. In other features, the method includes selectively identifying one or more entities within the received text and including all of the one or more entities in the query sent to the search system. In other features, the method includes selectively identifying an entity within a message from a second user to the first user device. The method includes selectively identifying a phrase corresponding to an action within the message from the second user. The method includes, in response to identifying the entity and the action within the message, modifying the display on the first user device to visually emphasize a portion of the message.

In other features, the method includes, in response to (i) identifying the action in the received text and (ii) previously having identified an entity in the received text, modifying the display on the first user device to visually emphasize a second portion of the text typed by the first user. The second portion of the text corresponds to the identified action. In other features, the method includes identifying the entity within the received text based on (i) a set of entities stored in an entity data store and (ii) a set of pattern matching rules.

In other features, the method includes storing a plurality of records. Each record (i) identifies search functionality of a respective application, (ii) includes a path to reach a search input state corresponding to the identified search functionality within the respective application, and (iii) includes an indication of required input parameters to be supplied in the search input state to access the identified search functionality. The method includes, in response to the query, selecting a set of records from stored records. Each record of the selected set of records (i) has required input parameters that match the identified entity of the query and (ii) has search functionality corresponding to the identified action of the query.

In other features, the method includes, for each record of the set of records, controlling an emulator to navigate the application specified by the record to the search input state specified by the record, supplying the required input parameters to the search input state specified by the record, performing a search, and scraping content from a resulting state to produce a content object. The content object includes a path to a first result specified by the resulting state. The method includes transmitting the content objects to the first user device. In other features, the method includes determining an order of the content objects based on sponsorship of respective applications from which the content objects were obtained. The method includes transmitting the order with the content objects.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIGS. 1-6 are example user interface mockups of an example implementation of the principles of the present disclosure.

FIG. 7 is a high-level functional block diagram of example data exchange between systems of the present disclosure.

FIG. 8 is a functional block diagram of an example implementation of a messaging app.

FIG. 9 is a functional block diagram of an example implementation of a search system.

FIG. 10 is a functional block diagram of another example implementation of a messaging app.

FIG. 11 is a functional block diagram of an example implementation of a messaging server.

FIG. 12A and FIG. 12B together form a flowchart of example operation of a messaging app according to the principles of the present disclosure.

FIG. 13 is a flowchart of example operation of a search system according to the principles of the present disclosure.

In the drawings, reference numbers may be reused to identify similar and/or identical elements.

### DETAILED DESCRIPTION

As a user of a messaging service sends and receives messages from their contacts, the user may recognize other tasks that they wish to perform on their mobile device. For example, when discussing plans for an upcoming evening, the user may decide to look up a restaurant or find the show times of a movie. In other situations, the user may think about looking up additional information about a topic of discussion or buying a product that was discussed.

If these future actions by the user could be predicted and facilitated by the messaging system, the user's use of the mobile device could be made more efficient. For example, if a product were being discussed, and the messaging system provided a deep link to purchase that product in an app already installed on the user's mobile device, the purchase action of the user could be performed far more quickly than with the traditional method. In the traditional method, the user has to remember which app may be best for which action, find and open that app, and perform a search, possibly repeating this process across multiple alternative apps.

To make deep links non-intrusive, the messaging system may simply emphasize the words of the user, or the words of the other party to the conversation, to indicate that those words may lead to an action. For example only, if a movie that is in theaters is being discussed, the name of the movie may be visually emphasized. This emphasis indicates to the user that the text corresponding to the name of the movie can be selected to perform an action related to that movie.

As an example, if, at the time the movie Iron Man was in theaters, a user was discussing Iron Man with a friend, the title “Iron Man” may be underlined to appear similar to a web link. This indicates to the user that the link can be selected to see actions related to the movie Iron Man. In various implementations, clicking or tapping that link will cause the messaging system to provide a list of potential activities to the user, which may include buying tickets, looking up reviews, etc. This list of actions may include those that can be performed with apps already installed on the device and additionally or alternatively may include actions that can be performed with apps not already installed on the mobile device.

The messaging system may parse each message sent by the user and each message received by the user and visually emphasize text that the messaging system recognizes as an entity, as an action, or as a combination of action and entity. For example, the messaging system may detect that the user is talking about watching something. The something may not be identifiable as an entity, but the action “watch” is generally associated with visual media, such as movies and television. Therefore, the messaging system may emphasize the word “watch” as well as the unspecified entity. If the user selects that link, a search can be performed for the unknown entity across a number of apps that provide “watch” functionality.

Similarly, as described above, if the messaging system detects the entity “Iron Man” but does not recognize what action the user may be interested in with respect to the Iron Man movie, the messaging system may emphasize the words “Iron Man.” If the user selects the Iron Man link, the search system may perform a search across apps that have search functionality where the input parameter is a movie name. This may return results for buying tickets, reading reviews, etc.

The visual emphasis may take the form of underlining and a color change to approximate a web link or may cause a button shape to be drawn where the text that led to the link being determined is placed within the button. In other implementations, links may be shown at the top of the display. To save screen real estate and not crowd out the actual messages, the display may be limited to the most recent one or two links identified by the messaging system.

The messaging system may consult a search system to return results for an action, an entity, or an action-entity pair. In other implementations, a messaging system may include its own search functionality. When a separate search system is providing search functionality, the search system may supply a search plugin to the messaging system to allow the messaging system to access the search functionality.

In some implementations, the search system library is incorporated into the app of a messaging system and executes on the user device. The search system library may perform some or all of the tasks related to identifying actions, identifying entities, performing searches, and traversing deep links. For more information about the format and handling of deep links, see commonly-assigned U.S. patent application Ser. No. 14/986,434 filed Dec. 31, 2015 titled “Cooperative Web-Assisted Deep Link Redirection,” with first-named inventor Shravan Sogani, the entire disclosure of which is incorporated by reference.

Although described so far using only a single entity, the detection features of the present invention may detect multiple entities. For example, a user may ask a colleague “Are there any good Thai restaurants in Sunnyvale?” The messaging system may detect Thai as an entity of type cuisine and Sunnyvale as an entity of type city. These entities may be combined together to identify a relevant search, which has input parameters of location and cuisine. If the messaging system can infer that reading restaurant reviews is the action desired by the user, this action combined with the Thai and Sunnyvale entitles are provided to the search system.

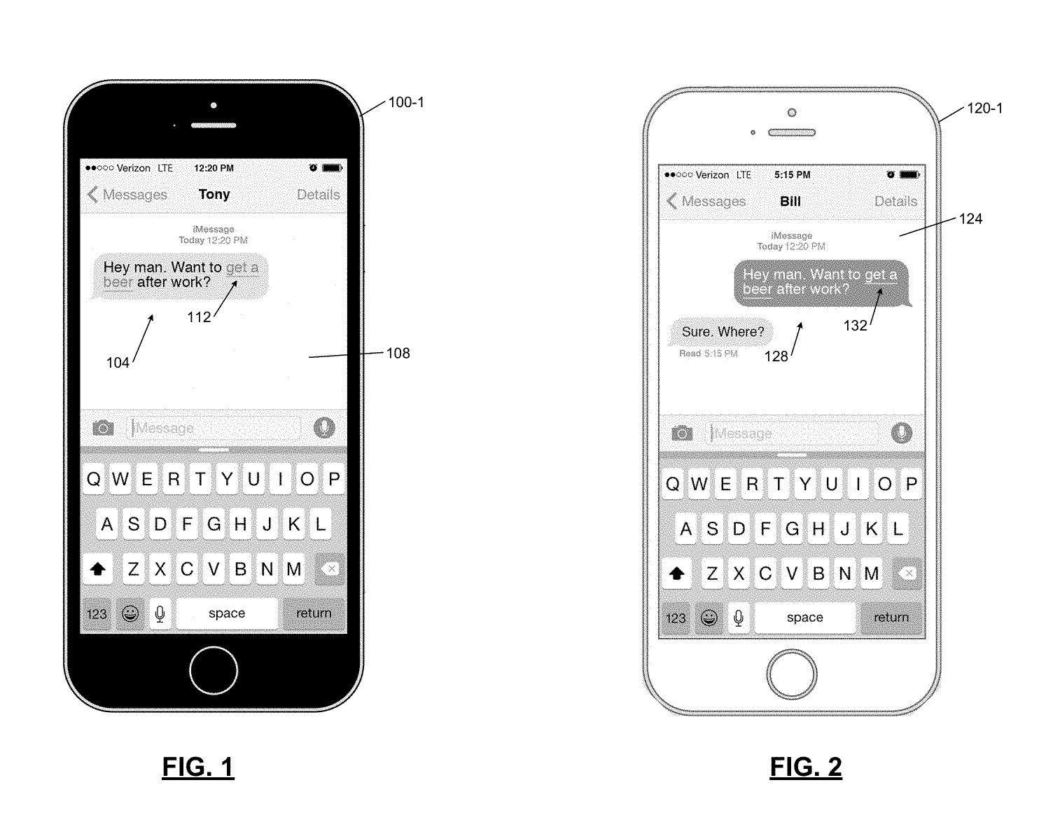

In FIG. 1, a first view 100-1 of a mobile device 100 is shown. Although the mobile device 100 is depicted as being a smartphone, the mobile device 100 may be a laptop, a tablet, a smartwatch, etc. A user (in this case, Tony) sends a message 104 to a contact (Bill as seen in FIG. 2). The message 104 includes a phrase “get a beer” that corresponds to a future action the user may want to perform on the mobile device 100. A messaging app 108 within which the user typed the message 104 may underline and change the color of “get a beer” to indicate a potential action. The text “get a beer” may then be referred to as deep link 112.

In FIG. 2, a first view 120-1 of a mobile device 120 for a second user (Bill) is shown. A messaging app 124 (which may be another copy of the messaging app 108) executing on the mobile device 120 shows a copy 128 of the message 104. The messaging app 124 may underline “get a beer” to indicate that the second user can select this link to see corresponding actions. The text “get a beer” may be referred to as deep link 132.

In various implementations, the messaging app 124 may identify and create links separately from the messaging app 108. In other implementations, the messaging app 124 may receive information about deep links supplied by the messaging app 108 along with the copy 128 of the message 104.

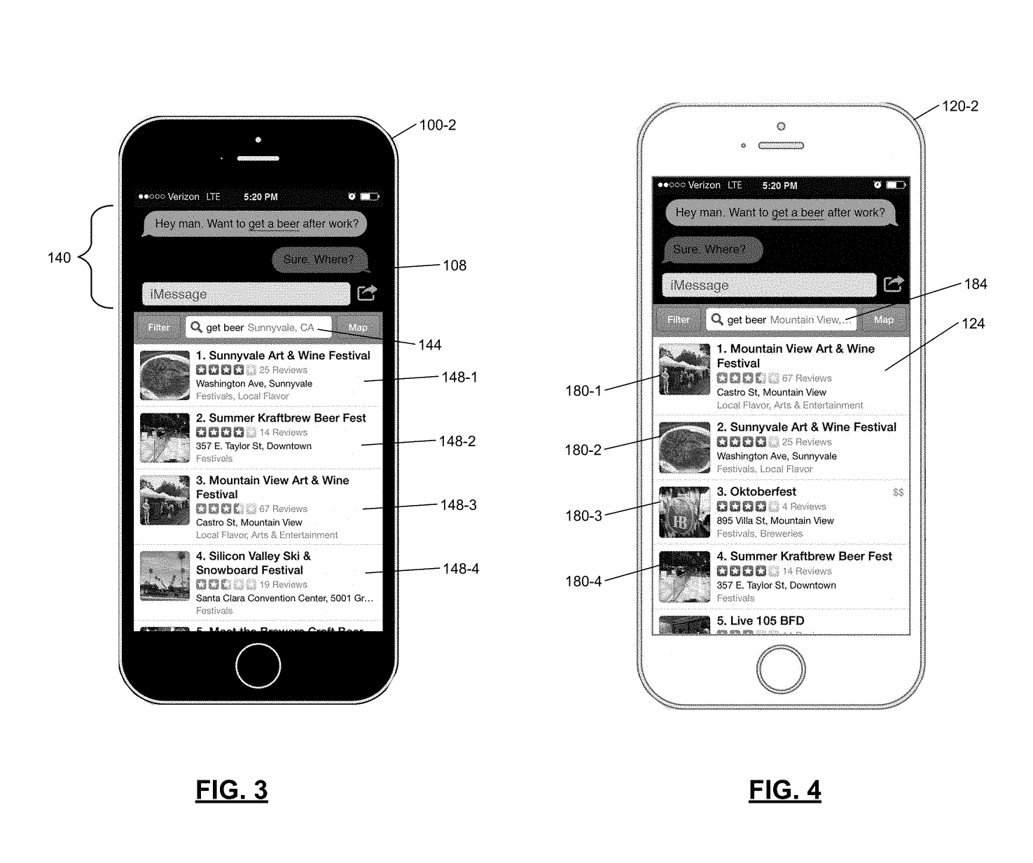

In FIG. 3, a view 100-2 of the mobile device 100 indicates an example implementation of a user interface produced when the user selects the deep link 112. A messaging portion 140 of the messaging app 108 may be compressed to allow room for deep link results. A query 144 is shown and may be based on the highlighted text of the deep link 112 and other contextual information, such as location (in this example, Sunnyvale, Calif.).

Results 148-1, 148-2, 148-3, and 148-4 (collectively, results 148) each correspond to a deep link into an app corresponding to the search query 144. In various implementations, the results 148 may be from a single application or from multiple applications. The results 148 may be in the form of deep view cards (DVCs).

A DVC for an app or a state of an app shows additional information, not just the identification of the app or app state. For example, the information may include a title of the app state or a description of the app state, which may be a snippet of text from the app state. Other metadata may be provided from the app state, including images, location, number of reviews, average review, and status indicators. For example, a status indicator of “open now” or “closed” may be applied to a business depending on whether the current time is within the operating hours of the business.

Some DVCs may emphasize information that led to the DVC being selected as a search result. For example, text within the DVC that matches a user's query may be shown in bold or italics. The DVC may also incorporate elements that allow direct actions, such as the ability to immediately call an establishment or to transition directly to a mapping app to get navigation directions to the establishment.

Other interactions with the DVC (such as tapping or clicking any other area of the DVC) may take the user to the indicated state or app. As described in more detail below, this may be accomplished by opening the relevant app or, if the app is not installed, opening a website related to the desired app state. In other implementations, an app that is not installed may be downloaded, installed, and then executed in order to reach the desired app state.

In other words, a DVC includes identifying information for the app or state as well as additional content from the app or state itself. The additional content allows the user to make a more informed choice about which result to choose, and may even allow the user to directly perform an action without having to navigate to the app state. If the action the user wants to take is to obtain information, in some circumstances the DVC itself may provide the necessary information to accomplish such action.

In FIG. 4, a view 120-2 of the mobile device 120 is shown after the second user selects the deep link 132. Results 180-1, 180-2, 180-3, and 180-4 (collectively, results 180) are based on a query 184 that may be similar to the query 144. However, note that contextual information, such as location, is different in the query 184 (Mountain View) compared to the query 144 (Sunnyvale). Therefore, the results 180 are not identical to the results 148.

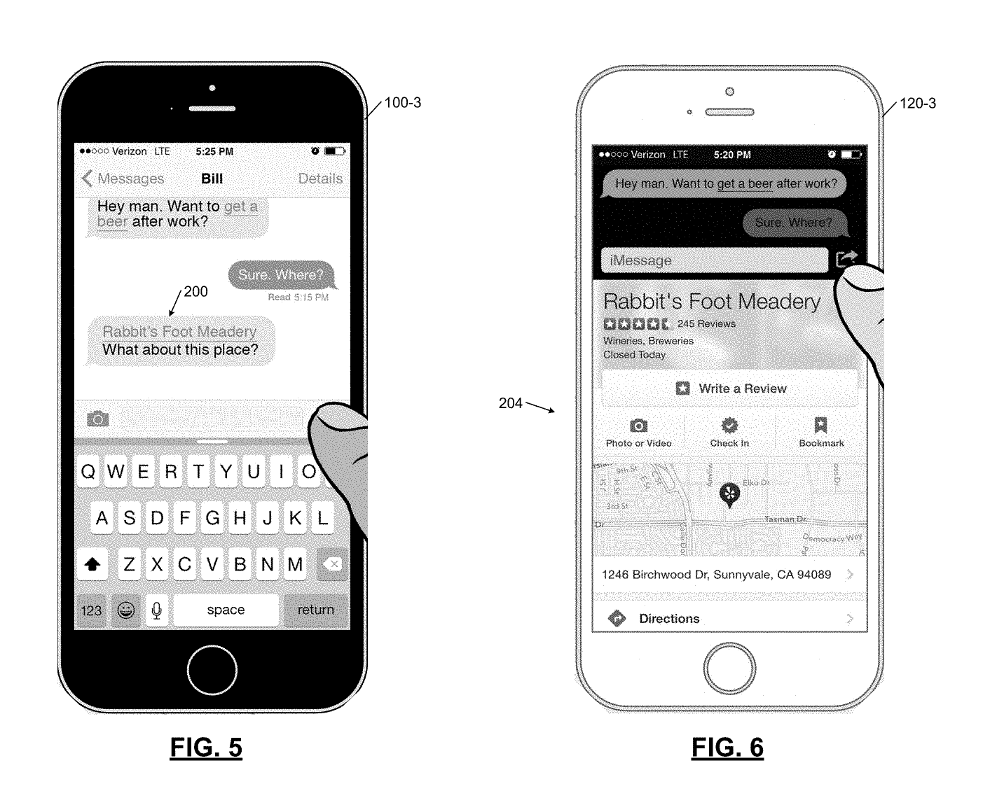

In FIG. 5, a view 100-3 of the mobile device 100 is shown. In this example, the user has selected a restaurant (Rabbit's Foot Meadery) and added a deep link 200 to a message. Sharing deep links or a DVC related to a deep link is described in more detail in commonly-assigned U.S. patent application Ser. No. 14/980,860, filed Dec. 28, 2015, titled “Sharing Cards to a Target Application,” with first-named inventor Manikandan Sankaranarasimhan, the entire disclosure of which is incorporated by reference.

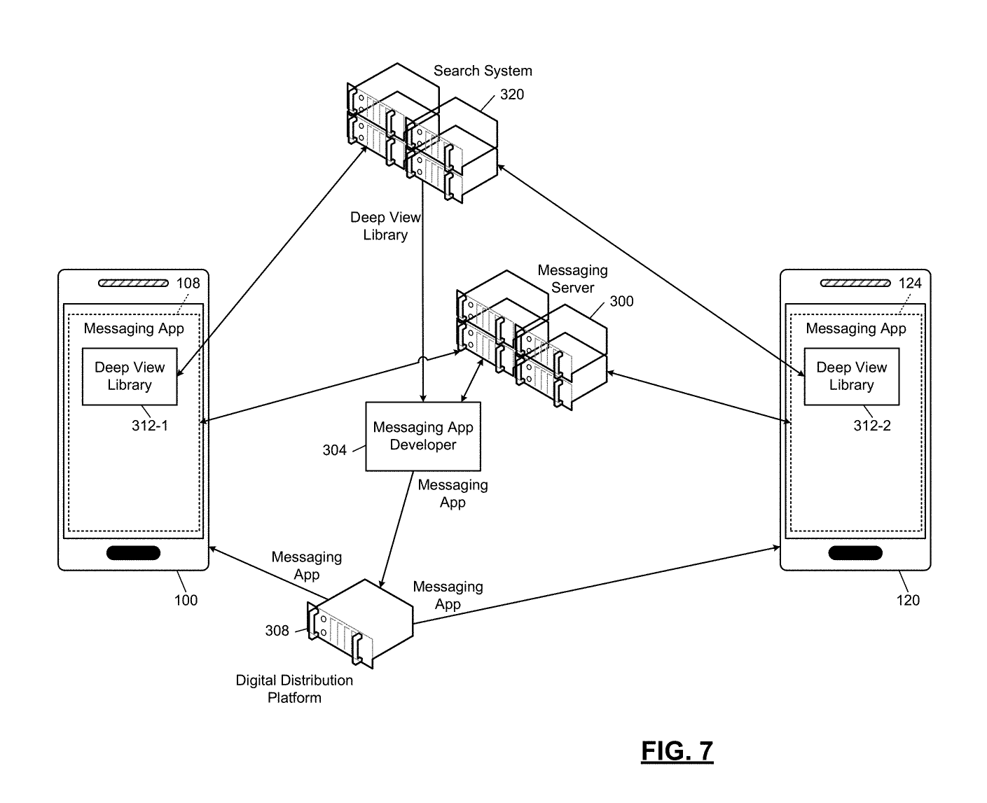

In FIG. 6, a view 120-3 of the mobile device 120 is shown. When the shared deep link 200 arrives at the mobile device 120, the second user may select the deep link 200 to open a deep view 204 of the restaurant. A deep view includes a variety of image data, including a map and text data. From the deep view 204, the second user can perform tasks such as getting directions and, in some implementations, may be able to open an app directly that has the information about this restaurant.

In FIG. 7, the mobile devices 100 and 120 are shown interacting with a messaging server 300. The messaging server 300 is under the control of a messaging app developer 304. The messaging app developer 304 may distribute the messaging app to the mobile devices 100 and 120 via a digital distribution platform 308. Some examples of the digital distribution platform 308 are the PLAY STORE from Google, Inc. and the APP STORE from Apple, Inc.

Each copy of the messaging app (108 and 124) includes a deep view library, 312-1 and 312-2, respectively. The deep view libraries 312-1 and 312-2 communicate with a search system 320. In various implementations, and as shown in FIG. 7, the search system 320 provides the deep view library to the messaging app developer 304 for incorporation into the messaging app.

While the data flow in FIG. 7 is shown with solid lines, the various devices and systems in FIG. 7 may actually communicate with each other via a network (not shown) instead of directly communicating. The network may include wired and wireless local area networks, mobile phone networks, personal area networks, and wide area networks such as the Internet.

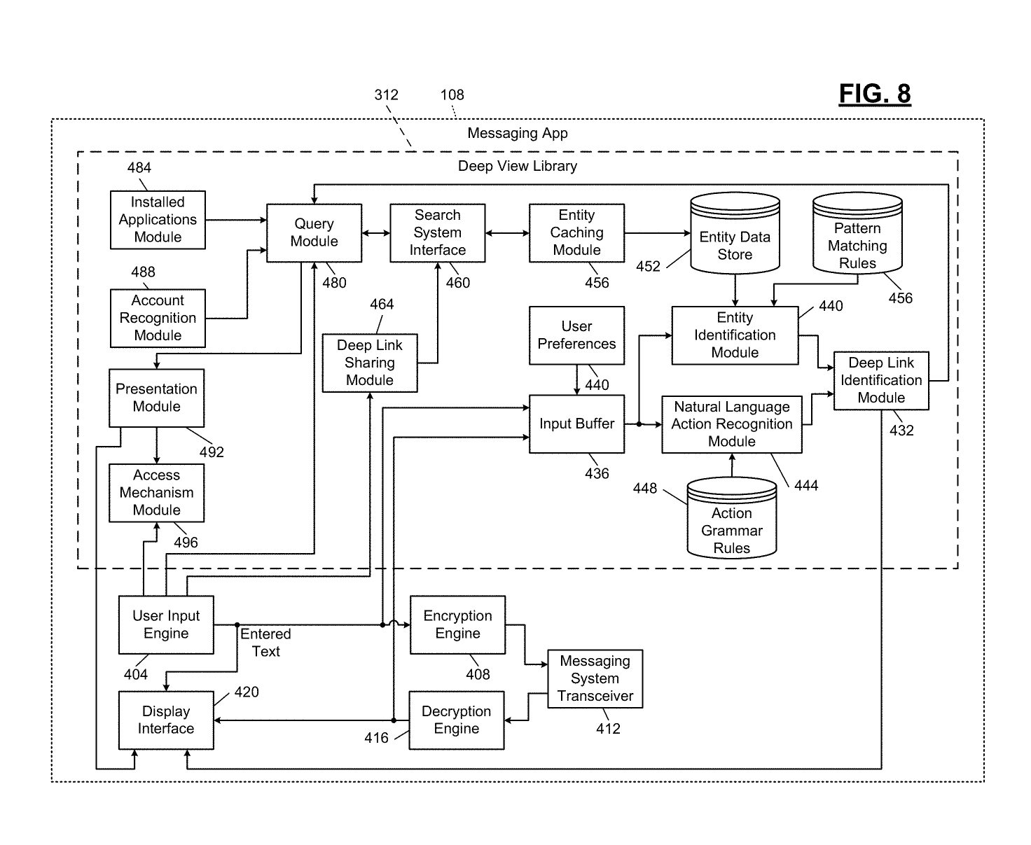

In FIG. 8, a functional block diagram of an example implementation of the messaging app 108 includes an example implementation of the deep view library 312. In various implementations, some of the components shown to be part of the deep view library 312 may be implemented as part of the messaging app 108 separate from the deep view library 312.

Outside of the deep view library 312, a user input engine 404 receives input, including text, selections, and gestures, from the user. The user input engine 404 may include various keyboards and other input mechanisms that may allow for emojis, animations, etc. Entered text is provided to an encryption engine 408 in this example implementation in which the messaging app 108 supports end-to-end encryption.

A messaging system transceiver 412 transmits encrypted data to the messaging system and receives encrypted data from the messaging system. The received encrypted data is provided to a decryption engine 416 and the decrypted messages are provided to a display interface 420. The messages are displayed to the user by the display interface 420.

The messaging app 108 is greatly simplified for this illustration in comparison to many real-world messaging apps. In various implementations of the messaging app 108, additional information may be exchanged with the messaging system via the messaging system transceiver 412. For example, presence data (whether the user is available to chat and how long since the user has last seen a message), contacts, file sharing, and message-entry-in-progress indicators are not shown.

In the deep view library 312, a deep link identification module 432 determines whether entered text should be emphasized and attached to a deep link. If so, the deep link identification module 432 informs the display interface 420, which applies a visual emphasis, such as an underlining or a button outline. Otherwise, the display interface 420 simply displays the entered text from the user input engine 404.

To determine whether text should be identified as a deep link, the entered text from the user input engine 404 along with received messages from the decryption engine 416 are provided to an input buffer 436 of the deep view library 312. The input buffer 436 may store entered text to be processed. In various implementations, the input buffer 436 only receives completed and sent messages. In other implementations, the input buffer 436 receives messages in progress and may pass partial messages along for analysis either continuously or at predetermined breakpoints, such as word boundaries.

User preferences 440 may allow for the deep view library 312 to be turned off. For example, if the user preferences 440 indicate that the user does not want deep links to be identified, the input buffer 436 may reject all incoming messages and, therefore, no deep links will be identified.

The input buffer 436 provides full or partial messages to an entity identification module 440 and a natural language action recognition module 444. The natural language action recognition module 444 may rely on a set of action parameter rules 448 to determine when actions appear in messages. For example, the action grammar rules 448 may include a list of verbs for various industry verticals, such as movies, restaurants, etc. The action grammar rules 448 may include conjugation rules so that various conjugations of each verb can be recognized.

Actions identified by the natural language action recognition module 444 are provided to the deep link identification module 432. The entity identification module 440 may rely on an entity data store 452, which stores a list of entities for various industry verticals. To save on storage space, the entity data store may be replaced by a search API (Application Programming Interface) that queries a search system for each potential entity. However, for privacy and security reasons, the entity data store 452 may be based on cached entity lists so that information about a user's messages are not transmitted to additional parties.

An entity caching module 456 periodically retrieves entities from a search system interface 460 that communicates with the search system. For example, the entity caching module 456 may download the most popular entities in a category. For example, the most popular entities in movie names may include all of the movies that are currently playing in first-run theaters as well as the top 100 or 1,000 most popular movies based on statistics from video content providers, such as Netflix.

When the entity identification module 440 recognizes an entity from the entity data store 452 in user text, the entity identification module 440 provides that entity to the deep link identification module 432. The entity identification module 440 may also rely on pattern matching rules 456, which allow for the identification of entities that may not be stored in the entity data store. For example, these pattern matching rules may identify addresses, phone numbers, etc. The pattern matching rules 456 may include regular expressions tailored to various entities encountered in messaging. Although not shown, the action grammar rules 448 and the pattern matching rules 456 may be updated periodically, such as via the search system interface 460.

If the user input engine 404 detects that the user wants to share a deep link or a deep view associated with a deep link, a deep link sharing module 464 of the deep view library 312 may make that deep link available through the search system interface 460. The search system may then provide the deep link to the other user. In other implementations, the shared deep link may be transmitted to the messaging system, such as via the encryption engine 408.

In response to the user selecting a deep link, the user input engine 404 sends a trigger signal to a query module 480. The query module 480 assembles a query based on the deep link from the deep link identification module 432 and the associated entity and/or action. The query module 480 may also include contextual information, such as location, operating system and version, screen resolution, etc.

In addition, the query module 480 may incorporate information about installed applications from an installed applications module 484. This information may be used by the search system to, for example, promote apps that are not yet installed but are being sponsored by an advertiser, or to promote apps that are already installed to allow for faster access by the user.

The query module 480 may also include information about active accounts on the mobile device, which may be tracked by an account recognition module 488. For example only, if a user expresses an interest in watching a movie, and the account recognition module 488 indicates that an active Netflix account is present, the search system may promote Netflix search results, which presumably will be immediately viewable by the user.

The query module 480 sends the query to the search system via the search system interface 460. When the query module 480 receives results by the search system interface 460, these results are provided to the display interface 420 by a presentation module 492. The presentation module 492 may assemble DVCs, which may include scaling images, flowing text, etc.

In addition, the presentation module 492 may include all of the code necessary to view search results, and therefore, the display interface 420 may simply provide a certain amount of screen real estate to the presentation module 492 for the presentation of search results. In response to the user input engine 404 detecting user selection of one of the search results, an access mechanism 496 uses an access mechanism to navigate to the selected search result.

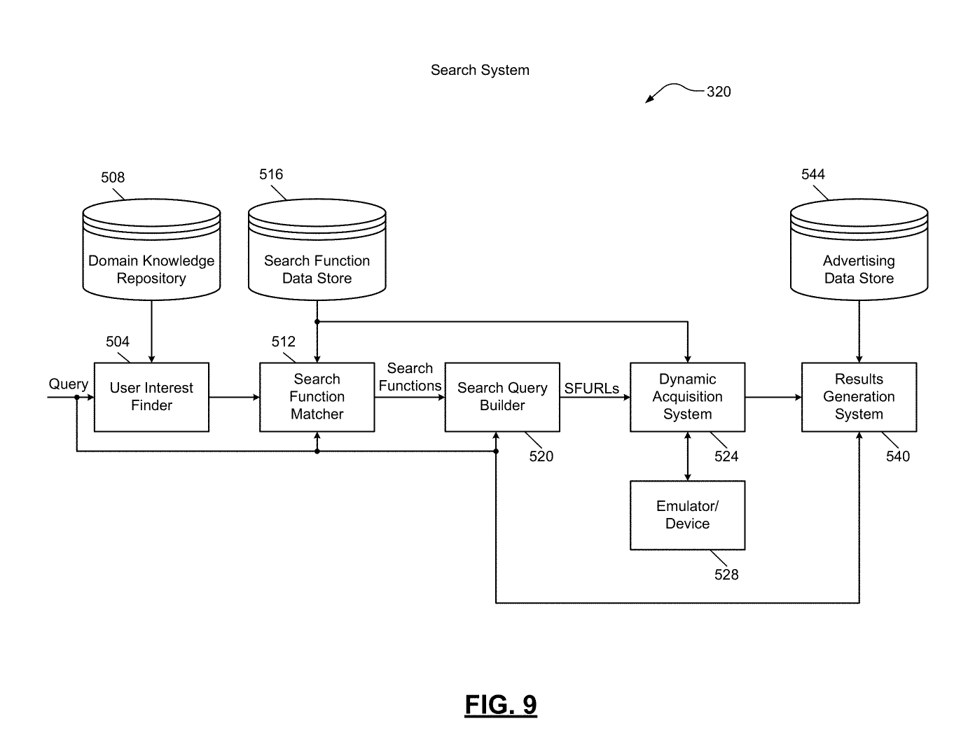

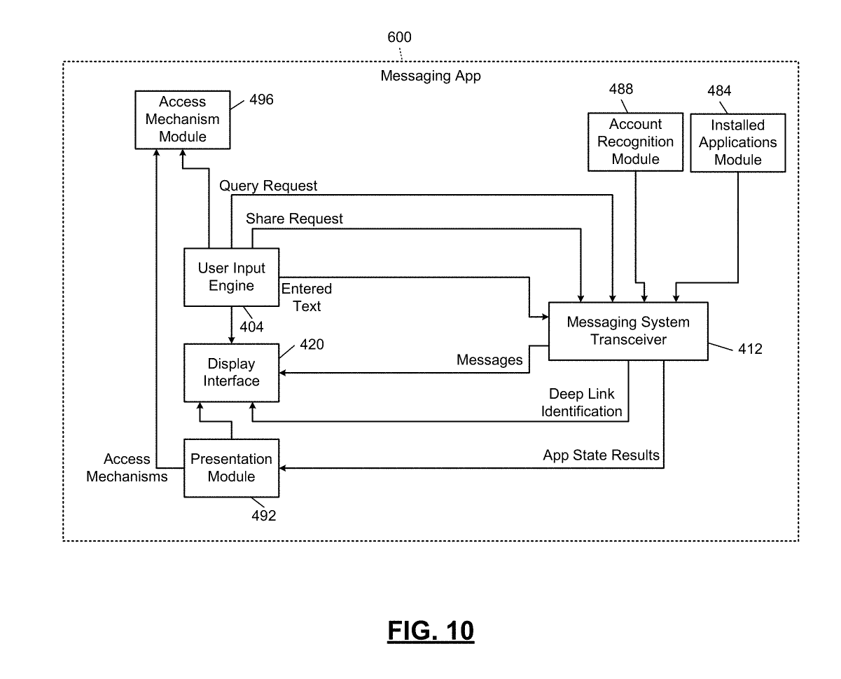

In FIG. 9, an example implementation of the search system 320 is shown. A user interest finder 504 attempts to recognize what entity types have been provided in a user query. This entity type detection may be based on a domain knowledge repository 508. Multiple different interpretations of the query may be output by the user interest finder 504. For example only, a certain string may be a movie name as well as the name of a video game. The most likely interpretations are provided to a search function matcher 512.

As a simple example, the domain knowledge repository 508 may have text data about a variety of industry verticals. For example, the domain knowledge repository 508 may have lists of restaurant names, lists of movie names, lists of actor names, lists of video games, lists of states and provinces, etc. Strings can be matched against the lists in the domain knowledge repository 508 to infer what type of entity the string refers to. Entity type detection is described in more detail in commonly-assigned U.S. Prov. App. No. 62/220,737 filed Sep. 18, 2015, titled “Entity-Type Search System,” with first-named inventor Sudhir Mohan, the entire disclosure of which is incorporated by reference.

The user interest finder 504 may output one or more query parses based upon the query, the domain knowledge repository 508, and in some implementations, one or more context parameters. A query parse is a data structure that defines a possible interpretation of the query.

The query parse may be structured as a parse tree. In some implementations, the parse tree is a structure where a leaf node contains a query term or combination of query terms, a potential entity type of the query term or combination of query terms, and an entity score. In these implementations, the intermediate nodes above the leaf nodes define logical operators (e.g., OR or AND). A query parse may be represented in any other suitable manner.

In a first example, a query may be “jfk lax.” In this example, “jfk” may be an airport code (John F. Kennedy International Airport in New York, N.Y.) or the initials of former United States President John F. Kennedy, while “lax” may be an airport code (Los Angeles International Airport) or an abbreviation of the name of a sport (lacrosse). In this example, the user may be searching for airplane tickets between LAX and JFK, an article about former President Kennedy being a lacrosse player, or information on a high school lacrosse team (e.g., the lacrosse team of JFK High School).

Of these, the most likely is the travel-related query. Thus, the entity scores of the airport entity type (LAX and JFK) are likely to be much higher than the entity scores of other entity types (e.g., sport or high school). In this example, the user interest finder 504 can output three (or more) query parses.

A first query parse can identify the query terms, “lax” and “jfk,” can assign the entity type “airport code” to each query term, and can determine an entity score for each assignment (e.g., 0.8 that lax is an airport code and 0.7 that jfk is an airport code). A second query parse can identify the query terms, “lax” and “jfk,” and can assign the entity type “sport” to “lax,” the entity type “person” to “jfk,” and an entity score to each respective assignment (e.g., 0.15 that lax is a sport and 0.25 that “jfk” is a person).

A third query parse can assign the entity type of “high school” to “jfk,” the entity type sport to “lax,” and entity scores to each respective entity type assignment. In some implementations, these query parses may be represented in a parse tree (e.g., each individual query parse is represented by one or more leaf nodes and connected to the other query parses with an OR node).

The user interest finder 504 determines the query parses by leveraging the domain knowledge repository 508. In some implementations, the domain knowledge repository 508 includes one or more entity tables and a set of parsing rules defining rules with which to parse the query. In these implementations, an entity table is a lookup table that relates a term or combination of terms to the possible entity types of the term or combination of terms.

Each relation can also have an associated entity score that is a probability value that indicates a likelihood that the term is of that entity type. The entity scores can be determined, for example, heuristically by analyzing large sets of text and documents. The parsing rules can define semantic rules that instruct a parser how to parse a query and to draw inferences based on the results of parsing.

The domain knowledge repository 508 can include any other additional or alternative data structures. For example, in some implementations, the domain knowledge repository 508 is structured in accordance with an ontology. The ontology may define relationships between general entity types and app-specific entity types. For example, the cuisine “Thai cuisine” general entity type may relate to a “Thai” app-specific entity type for a first software application and “Thai food” app-specific entity type for a second software application.

In this way, the first software application's schema refers to “Thai cuisine” as “Thai,” and the second software application's schema refers to “Thai cuisine” as “Thai food.” Furthermore, entity types may relate to other entity types. For example, the general entity type “Thai cuisine” may reference an “Asian cuisine” entity type, since Thai cuisine may be thought of as a subclass of “Asian Food.”

Further, the “restaurant” entity type may relate to an “address” entity type, a “cuisine” entity type, and any other relevant classifications. An “address” entity type may include a “street address” entity type, a “state” entity type, a “city” entity type, and a “zip” entity type. The domain knowledge repository 508 includes data points that populate the ontology. For example, the string “Thai” may be related to “Thai cuisine,” while the string “Tom's Thai” may relate to a “Thai cuisine” entity type and a “restaurants” entity type.

As the search system 320 learns about new entities, the search system 320 can connect the new entity to its corresponding entity types. In this way, the domain knowledge repository 508 indicates how an entity relates to other entities and the entity type(s) of the entity given the ontology. For instance, the entity “Tom's Thai” may be linked to a state entity “California,” a city entity “Mountain View,” and a zip code entity “94040.”

A query including the query terms “Tom's Thai” that was received from a location near Mountain View, Calif. would likely be interpreted as implicating the “Tom's Thai” entity. Furthermore, as the ontology also includes app-specific entities, the search system 320 may be able to represent the restaurant name “Tom's Thai” in a manner that is understood by third party applications (e.g., “1234821” for a first application and “Toms_Thai” for a second application).

In some implementations, the ontology and its corresponding data points (i.e., the specific entities) may be indexed and stored in the domain knowledge repository 508. For example, the search system 320 may index the ontology and corresponding data points into one or more entity tables. In these implementations, components of the search system 320 can query the entity tables with a query term, and if the query term (or combination of query terms) is listed in the entity table as an entity, the entity table returns to potential entity type(s) of the query term (or query terms).

In some implementations, the user interest finder 504 includes one or more parsers that implement the parsing rules and use the entity tables and/or the populated ontology to identify potential entity types and determine corresponding entity scores. For example, the user interest finder 504 may include a restaurant parser that parses the query to identify restaurant names, a cuisine parser that parses the query to identify cuisine names, a media parser that parses the query to identify media related terms (e.g., song titles, movie titles, album titles), a person parser that parses the query to identify names of people, an action parser that parses the query to identify names of actions (e.g., “read,” “watch,” “view,” “make reservation,”), a place name parser that parses the query to identify names of places, an airport parser that parses the query to identify airport names or airport codes, a time parser that parses the query to identify dates and times, and an application name parser that parses the query to identify names of applications.

The parsing rules may define language constructs that indicate the intention of the user. For example, a parsing rule may instruct the user interest finder 504 to identify stop words such as “to” or “in” when parsing the query to determine whether a query term or combination of query terms is a place name (e.g., “Thai restaurants in Mountain View” or “taxi to Detroit”).

When such a stop word is identified, the parser can look up the query term(s) following the stop word in an entity table that defines place names. If the query term(s) are in the entity table, the entity type defined in the table is assigned to the query term(s) as a potential entity type, and the entity score defined in the entity table is assigned to the potential entity type. In another example, a parsing rule may instruct a parser to analyze the query for particular action terms such as “watch,” “view,” “stream,” or “read.”

When the parser encounters one of these action words, the parsing rules can instruct the parser to compare the query term(s) against an entity table that defines media and book titles. In the event a media or book title follows the action word, the parser can assign the entity type (e.g., “movie” or “book”) to the query term(s) following the action word and can assign the entity score defined in the entity table to the entity type. In the event two different constructions of a query exist, the query analysis module can create query parses, whereby the different query parses the different interpretations of the query.

For instance, if the query is “lax,” the user may be referencing the sport or the airport. In this instance, the user interest finder 504 may create a query parse that represents a query directed to an airport and a query parse that represents a query directed to a sport. In some implementations, the user interest finder 504 can connect the query parses with an intermediate node (OR), thereby generating a parse tree. The user interest finder 504 outputs the entity types for the various query parses to the search function matcher 512.

The search function matcher 512 selects search functions from a search function data store 516 that have input parameters matching the parameters recognized by the user interest finder 504. The search function data store 516 is populated for each app using an onboarding process. During the onboarding process, configurators (which may include human operators and/or automated algorithms) identify what searches can be performed in an app and what types of entity data is specified in each search.

The set of relevant search functions is provided to a search query builder 520. The search query builder 520 combines the generic search function with specific values from the query. The resulting populated search functions may be referred to as Search Function Uniform Resource Locators (SFURLs). For illustration only, an example SFURL is presented here:

func://googleplay/android/com.ted.android/39/VXhV_hNM?p0=
wearing%20nothing%20new

As shown, a Search Function URL (SFURL) may encode a name (“googleplay”) of the digital distribution platform from which the app was obtained, since different digital distribution platforms may have different versions of an app. The SFURL may also have an indicator (“googleplay”) of the operating system for the app, a name (“com.ted.android”) of the app, a version (“39”) of the app, and an identifier (“VXhV_hNM”) of the specific search function. The SFURL may also include a serialized sequence of parameters to provide to the search function. A first parameter may be named p0 and have a value of “wearing nothing new.”

The search function data store 516 stores a guide for each SFURL indicating how to traverse the app from the home (or, default) state to the search input state where the search is performed. This guide may be a series of user interface (UI) interactions. The identifier in the SFURL may, in some implementations, be a hash of this guide.

The search function data store 516 may also store guide data for each input (also called a parameter) for the search. In other words, the guide dictates how a value can be supplied for a parameter within the search input state. For example, this may include an identification of a UI element corresponding to that parameter and what UI action to perform in order to control that parameter.

Because apps cannot always be launched to a specific state simply with a URL or other URI (Uniform Resource Identifier), the search system of the present application may navigate to a desired state with a combination of intent calls and user interface (UI) injection. The term “intent” is generally associated with the ANDROID operating system, but is used in this disclosure simply to refer to a programmatic approach to reaching a specific state. Corresponding elements for the IOS operating system may be referred to as view controllers.

UI replay may be used to simulate a user tapping or making other gestures in an app as well as for supplying data, such as text normally entered by a user through a soft keyboard. In various implementations, UI replay may be accomplished using an accessibility framework provided by the operating system or by a search-enabled app. Some states may be reached by a combination of intent invocation and UI replay. For example, an intent may be invoked to arrive at a search state, and then UI replay simulates a user typing text and clicking a search button.

A dynamic acquisition system 524 accesses data requested by the SFURLs. For example, the dynamic acquisition system 524 may access native apps running in emulators or devices, such as an emulator/device 528. The dynamic acquisition system 524 may also access web editions of an app using a live web scraping system. When using a native app, the dynamic acquisition system 524 may rely on search guides from the search function data store 516 to navigate to the appropriate state and supply the parameters to the app within the emulator/device 528.

Results (in the form of content objects) from the dynamic acquisition system 524 are received by a results generation system 540. Each content object corresponds to an application and to a specific state of that application. A developer may wish to sponsor their app in order to get greater exposure and/or greater engagement with the app. In addition, operators of entities such as restaurants and marketers of entities, such as movies, may desire to advertise their respective entities.

An advertising data store 544 stores information about which entities and apps are currently being sponsored. The results generation system 540 may rank apps and entities that are being sponsored higher and therefore display them preferentially. This preferential display may mean displaying sponsored results first in a list, in larger font, using more screen real estate, etc.

In FIG. 10, another example implementation of a messaging app 600 is shown. Although the same reference numerals are used, the functionality of the elements of the messaging app 600 may differ from that of the messaging app 108. Note that many of the elements of the messaging app 108 are missing. Some of these elements have been offloaded to a messaging server.

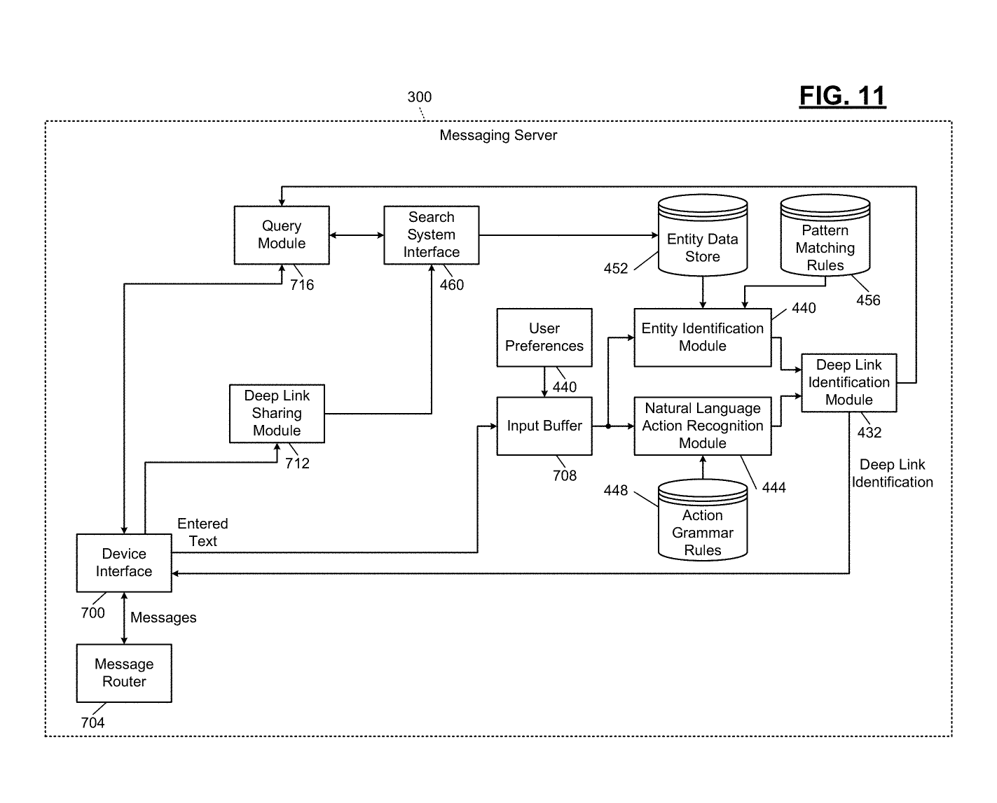

In FIG. 11, an example implementation of the messaging server 300 is shown. A device interface 700 communicates with the messaging system transceiver 412 of the messaging app 600 of FIG. 10. The device interface 700 may communicate with multiple devices and exchange messages with a message router 704. While tremendously simplified as a single rectangle, the message router 704 receives messages from devices and transmits them to other devices as indicated by routing information associated with the messages.

The device interface 700 provides entered text to an input buffer 708, which may be similar to the input buffer 436 of FIG. 8. Further, a share request from the user, as detected by the user input engine 404 of FIG. 10, is provided to a deep link sharing module 712, which may be similar to the deep link sharing module 464 of FIG. 8.

A query request, as detected by the user input engine 404 of FIG. 10, is provided to a query module 716, which may be similar to the query module 480 of FIG. 8. The remaining elements of FIG. 11 are shown with reference numerals matching those of FIG. 8 to indicate that functionality may be similar.

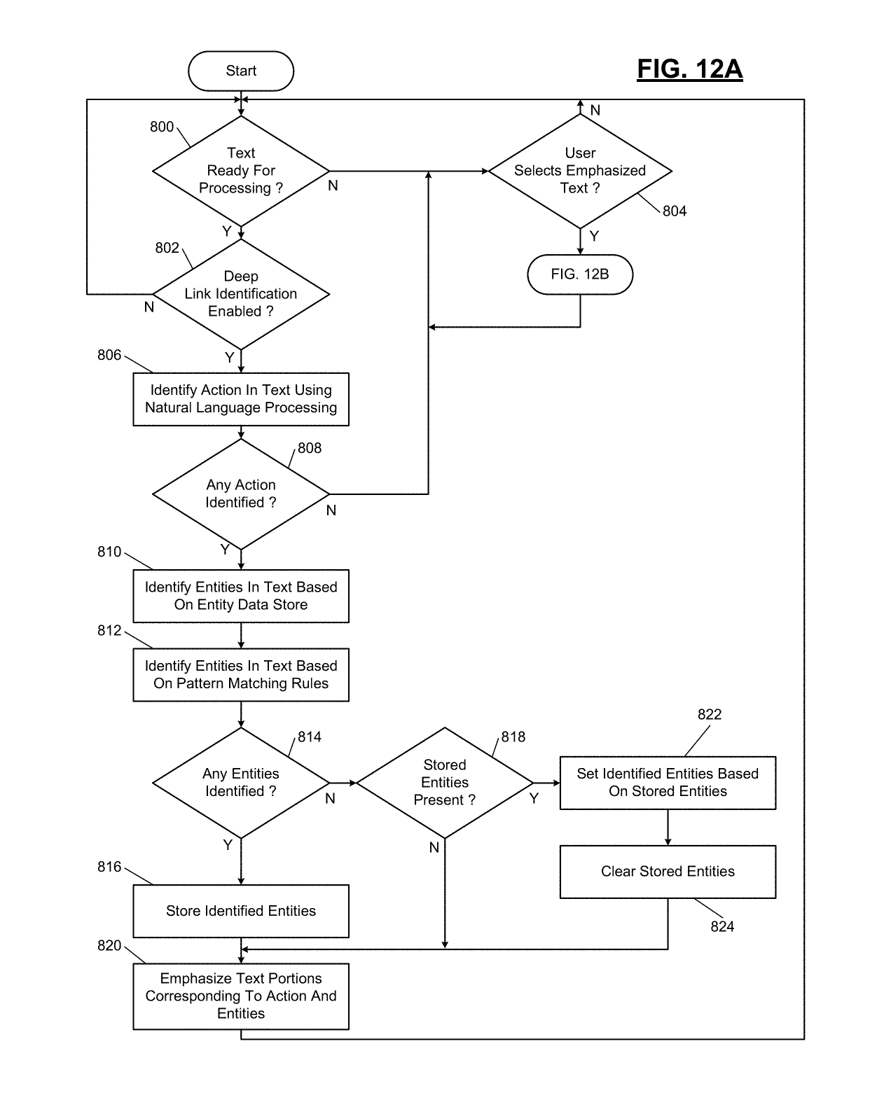

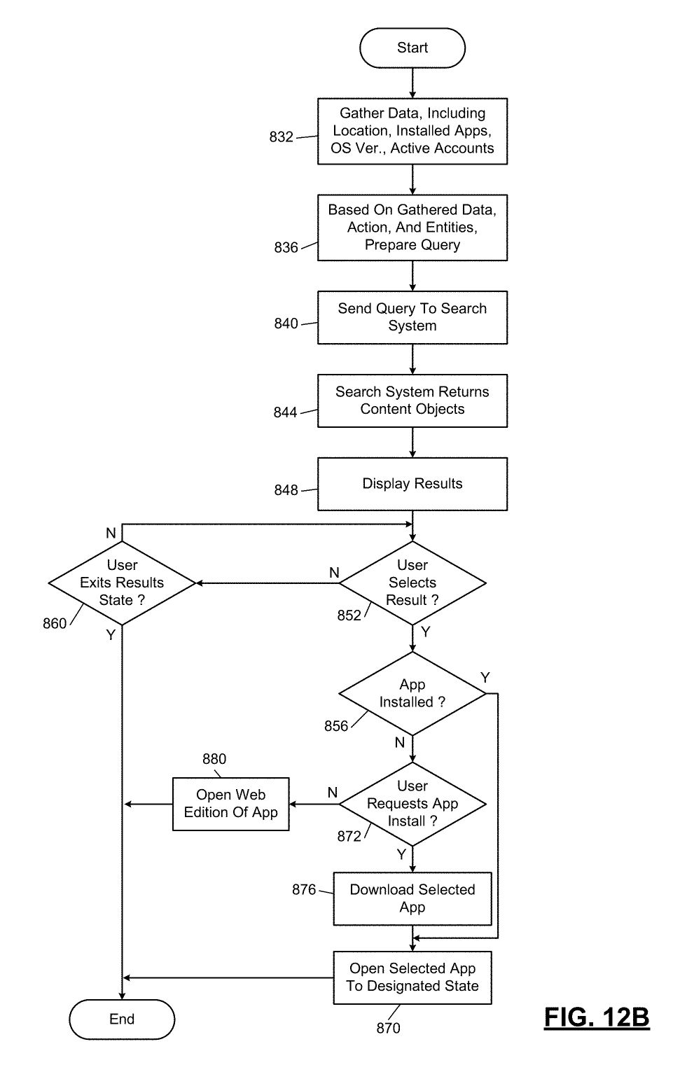

In FIG. 12A, control of an example deep view library begins at 800, where if text is ready for processing, control transfers to 802; otherwise, control transfers to 804. At 804, if the user selects emphasized text (the emphasis indicating that a deep link has been identified), control transfers to FIG. 12B. Otherwise, control returns to 800.

At 802, if deep link identification is enabled, control transfers to 806; otherwise, control returns to 800. At 806, control attempts to identify an action in the text using natural language processing. For example, control may use grammar rules to identify verbs and other actions. At 808, if an action has been identified, control transfers to 810; otherwise, control returns to 800.

At 810, control attempts to identify one or more entities in the text based on an entity data store. For example, control may compare hash values of phrases from the text with stored hash values from the entity data store. Control continues at 812, where control attempts to identify entities in the text based on pattern matching rules, such as regular expressions.

Control continues at 814, where if any entities were identified, control transfers to 816; otherwise, control transfers to 818. At 816, control stores the identified entities and continues at 820. At 818, control checks whether any stored entities are present. If so, control transfers to 822; otherwise, control transfers to 820. If one or more entities are stored, then the present action may apply to that stored entity. As one example, users had been discussing an entity, such as a restaurant, and later discuss reviews or directions without repeating the name of the restaurant.

At 822, control sets the identified entities based on the stored entities. Control continues at 824, where the stored entities are cleared. This prevents stored entities from getting stale and being used for actions well in the future. For example only, the stored entities may be cleared not after one use but after a period of time or after a certain number of messages have been exchanged with another party. Control then continues at 820. At 820, control emphasizes portions of the text corresponding to the identified action and the identified entities.

In FIG. 12B, control begins at 832, where control gathers context data from the user device, which may include one or more of the following: location, installed applications, operating system version, installed accounts, etc. At 836, based on the gathered data, the action, and the entities, a query is prepared. At 840, the query is sent to the search system. At 844, the search system returns content objects.

At 848, control displays results related to the content objects. At 852, if the user selects one of the results, control transfers to 856; otherwise, control transfers to 860. At 856, if the app corresponding to the selected search result is installed, control transfers to 870; otherwise, control transfers to 872.

At 872, control determines whether the user gives permission to install the app. If so, control transfers to 876; otherwise, control transfers to 880. At 880, control opens a web edition of the app. In situations where this is no web addition, an error message may be shown or other remedial action performed. Control then ends, returning to FIG. 12A. At 876, the selected app is downloaded, which may be referred to as deferred deep-linking. Control continues at 870 where the selected app is opened on the user device to the designated state. Control then ends. At 860, if the user exits the results state, control ends; otherwise, the user returns to 852.

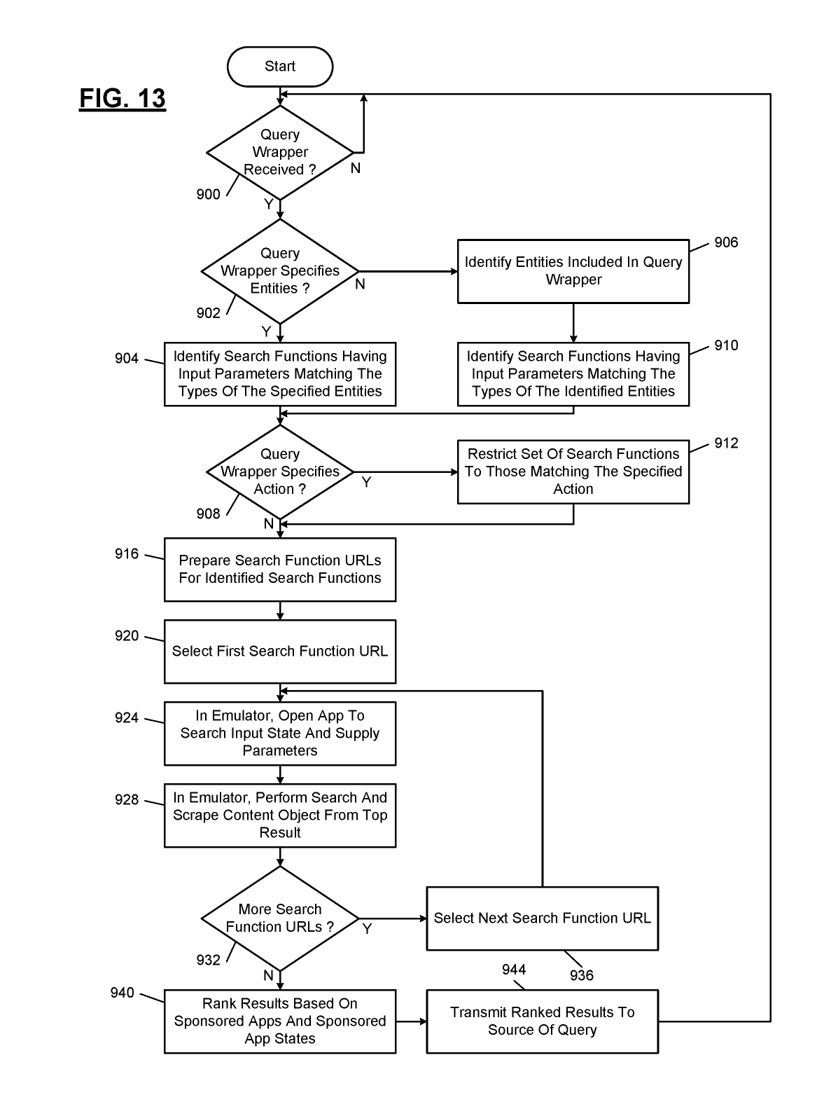

In FIG. 13, a flowchart of example control of a search system for use with a messaging system begins at 900. Control remains at 900 until a query wrapper is received. Control then continues at 902. At 902, if the query wrapper specifies entities, control transfers to 904; otherwise, control transfers to 906. At 904, control identifies search functions having input parameters matching the types of the specified entities in the query wrapper. Control continues at 908.

At 906, entities have not been specified in the query wrapper. For example, this may occur if the entities are not common and therefore were not cached within the messaging app. Control continues at 910, where control identifies search functions having input parameters that match the types of the identified entities. Control then continues at 908.

At 908, control determines whether the query wrapper specifies an action. If so, control transfers to 912; otherwise, control transfers to 916. At 912, control restricts the set of identified search functions to those matching the specified action. Control then continues at 916.

At 916, search function URLs (Uniform Resource Locators) are prepared for the identified search functions. For example only, a search function URL may include an identifier of the search input state where the search functionality can be accessed and an indication of parameters to be supplied to the search function, where the parameters are based on the query wrapper.

At 920, control selects the first of the search function URLs. At 924, control opens the app specified by the selected search function URL to the search input state specified. This app is executed in an emulator or in a hardware device under control of the search engine. Control then supplies parameters to the user interface elements of the search input state.

At 928, control executes the search in the emulator, such as by actuating a user interface element (for example, a search button). Control selects the first result, assuming that the app will place the most relevant content first, and scrapes that first result to create a content object. At 932, control determines whether there are more search function URLs. If so, control transfers to 936; otherwise, control transfers to 940. At 936, control selects the next search function URL and returns to 924.

At 940, control ranks the scraped content objects based on sponsorship of apps, app states, and entities that may appear in app states. Control continues at 944, where the ranked content objects are transmitted to the sender of the query wrapper. Control then returns to 900.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A messaging system comprising:
an input buffer configured to receive text typed by a first user into a first user device;
an entity identification engine configured to selectively identify an entity within the received text based on a set of entities stored in an entity data store;
a natural language action recognition engine configured to selectively identify a phrase corresponding to an action within the received text;
a deep link identification module configured to, in response to (i) the entity identification engine identifying the entity in the received text and (ii) the natural language action recognition engine identifying the action in the received text, modify a display on the first user device to visually emphasize a portion of the text typed by the first user, wherein the portion of the text corresponds to at least one of the identified entity and the identified action;
a search system interface configured to
in response to the first user expressing interest in the portion of the text, transmit a query to a search system, wherein the query includes the identified entity and the identified action;
receive a set of application state results, wherein each application state result includes (i) an identification of an application within which the application state is present, (ii) an identification of the application state, and (iii) an access mechanism that navigates to the application state within the first user device; and
cause the set of application state results to be presented to the first user.

2. The messaging system of claim 1 wherein the visually emphasizing the portion of the text includes at least one of:
adding a hyperlink to the portion of the text; and
replacing the portion of the text with a button containing the portion of the text.

3. The messaging system of claim 1 wherein:
the entity identification engine is configured to selectively identify one or more entities within the received text; and
the search system interface is configured to include all of the one or more entities in the query sent to the search system.

4. The messaging system of claim 1 wherein:
the input buffer, the entity identification engine, the natural language action recognition engine, the deep link identification module, and the search system interface are included in a library;
the library is integrated into a messaging application;
the messaging application is installed on the first user device;
the messaging application receives the text typed by the first user; and
the messaging application displays, on the first user device, the text typed by the first user.

5. The messaging system of claim 1 wherein:
the entity identification engine, the natural language action recognition engine, the deep link identification module, and the search system interface are implemented in a messaging server remote from the first user device; and
a messaging application installed on the first user device receives the text typed by the first user and displays, on the first user device, the text typed by the first user.

6. The messaging system of claim 1 wherein:
the entity identification engine is configured to selectively identify an entity within a message from a second user;
the natural language action recognition engine is configured to selectively identify a phrase corresponding to an action within the message from the second user; and
the deep link identification module is configured to, in response to (i) the entity identification engine the identifying the entity in the message and (ii) the natural language action recognition engine identifying the action in the message, modify the display on the first user device to visually emphasize a portion of the message.

7. The messaging system of claim 1 wherein the deep link identification module is configured to, in response to (i) the natural language action recognition engine identifying the action in the received text and (ii) the entity identification engine having previously identified an entity in the received text, modify the display on the first user device to visually emphasize a second portion of the text typed by the first user, wherein the second portion of the text corresponds to the identified action.

8. The messaging system of claim 1 wherein the entity identification engine is configured to identify the entity within the received text based on (i) a set of entities stored in an entity data store and (ii) a set of pattern matching rules.

9. A system comprising:
the messaging system of claim 1; and
the search system, wherein the search system includes
a search function data store configured to store a plurality of records, wherein each record (i) identifies search functionality of a respective application, (ii) includes a path to reach a search input state corresponding to the identified search functionality within the respective application, and (iii) includes an indication of required input parameters to be supplied in the search input state to access the identified search functionality; and
a search function matcher configured to, in response to the query, select a set of records from the search function data store, wherein each record of the selected set of records (i) has required input parameters that match the identified entity of the query and (ii) has search functionality corresponding to the identified action of the query.

10. The system of claim 9, wherein:
the search system includes a native search system configured to, for each record of the set of records:
control an emulator to navigate the application specified by the record to the search input state specified by the record;
supply the required input parameters to the search input state specified by the record;
perform a search; and
scrape content from a resulting state to produce a content object, wherein the content object includes a path to a first result specified by the resulting state, and
the search system transmits the content objects to the messaging system.

11. The system of claim 10 wherein the search system transmits an order with the content objects, wherein the order is determined based on sponsorship of respective applications from which the content objects were obtained.

12. A method of operating a messaging system, the method comprising:
receiving text typed by a first user into a first user device;
selectively identifying an entity within the received text based on a set of entities stored in an entity data store;
selectively identifying a phrase within the received text corresponding to an action;
in response to the entity and the action being identified in the received text, modifying a display on the first user device to visually emphasize a portion of the text typed by the first user, wherein the portion of the text corresponds to at least one of the identified entity and the identified action;
in response to the first user expressing interest in the portion of the text, transmitting a query to a search system, wherein the query includes the identified entity and the identified action;
receiving a set of application state results, wherein each application state result includes (i) an identification of an application within which the application state is present, (ii) an identification of the application state, and (iii) an access mechanism that navigates to the application state within the first user device; and
causing the set of application state results to be presented to the first user.

13. The method of claim 12 wherein the visually emphasizing the portion of the text includes at least one of:
adding a hyperlink to the portion of the text; and
replacing the portion of the text with a button containing the portion of the text.

14. The method of claim 12 further comprising:
selectively identifying one or more entities within the received text; and
including all of the one or more entities in the query sent to the search system.

15. The method of claim 12 further comprising:
selectively identifying an entity within a message from a second user to the first user device;
selectively identifying a phrase corresponding to an action within the message from the second user; and
in response to identifying the entity and the action within the message, modifying the display on the first user device to visually emphasize a portion of the message.

16. The method of claim 12 further comprising, in response to (i) identifying the action in the received text and (ii) previously having identified an entity in the received text, modifying the display on the first user device to visually emphasize a second portion of the text typed by the first user, wherein the second portion of the text corresponds to the identified action.

17. The method of claim 12 further comprising identifying the entity within the received text based on (i) a set of entities stored in an entity data store and (ii) a set of pattern matching rules.

18. The method of claim 12, further comprising:
storing a plurality of records, wherein each record (i) identifies search functionality of a respective application, (ii) includes a path to reach a search input state corresponding to the identified search functionality within the respective application, and (iii) includes an indication of required input parameters to be supplied in the search input state to access the identified search functionality; and
in response to the query, selecting a set of records from stored records, wherein each record of the selected set of records (i) has required input parameters that match the identified entity of the query and (ii) has search functionality corresponding to the identified action of the query.

19. The method of claim 18, further comprising:
for each record of the set of records:
controlling an emulator to navigate the application specified by the record to the search input state specified by the record;
supplying the required input parameters to the search input state specified by the record;
performing a search; and
scraping content from a resulting state to produce a content object, wherein the content object includes a path to a first result specified by the resulting state, and
transmitting the content objects to the first user device.

20. The method of claim 19 further comprising:
determining an order of the content objects based on sponsorship of respective applications from which the content objects were obtained; and
transmitting the order with the content objects.
